(19) United States
(12) Patent Application Publication
(10) Pub. No.: US 2025/0391106 A1
(43) Pub. Date: Dec. 25, 2025

(54) SYSTEM, DEVICE, AND METHOD FOR DETECTING OBJECTS BY SEPARATELY PROCESSING DATA IN MULTIPLE INPUT PATHS OF A NETWORK

(71) Applicant: Robert Bosch GmbH, Stuttgart (DE)

(72) Inventors: Alexander Bartler, Villingen-Schwenningen (DE); Claudius Glaeser, Ditzingen (DE); Daniel Niederloehner, Stuttgart (DE); Florian Faion, Staufen (DE); Jiaying Lin, Magstadt (DE); Marcel Schreiber, Neu-Ulm (DE); Maurice Quach, Ditzingen (DE); Michael Ulrich, Stuttgart (DE); Ruediger Jordan, Stuttgart (DE); Sascha Braun, Reutlingen (DE)

(21) Appl. No.: 19/245,492

(22) Filed: Jun. 23, 2025

(30) Foreign Application Priority Data
Jun. 24, 2024 (DE) 10 2024 205 839.4

(51) Int. Cl. G06T 17/00; G06V 20/52

(52) U.S. Cl. CPC G06T 17/00; G06V 20/52; G06V 2201/07

(57) ABSTRACT

A system, a device, and a method for detecting objects by separately processing point clouds including information about the surroundings of the system and/or the device. The method includes: separating a point cloud into a plurality of point clouds according to one or more features of a plurality of features of each point of the point cloud; preprocessing the plurality of point clouds in a plurality of input paths of a network corresponding to the respective point cloud; fusing the output data of the plurality of input paths of the network; and further processing the fused output data in the network to detect the objects.

### CROSS REFERENCE

The present application claims the benefit under 35 U.S.C. § 119 of German Patent Application No. DE 10 2024 205 839.4 filed on Jun. 24, 2024, which is expressly incorporated herein by reference in its entirety.

### FIELD

The present invention relates to a system, a device, and a method for detecting objects by separately processing data in multiple input paths of a network, in particular by separately processing data from static and dynamic objects.

### BACKGROUND INFORMATION

Driver assistance systems and systems that enable autonomous driving of a vehicle require an accurate depiction of the surroundings of the vehicle to make safe operation of the vehicle possible. Because they are comparatively robust to weather influences and also enable direct determination of speeds, radar technologies (radio detection and ranging, radar) are frequently used in addition to conventional imaging technologies and/or LiDAR technologies (light detection and ranging, LiDAR) to acquire the surroundings.

The raw data acquired by a radar device during a measurement, for instance, can be processed into a radar point cloud. Each point of the radar point cloud can be characterized, for example in polar coordinates, by a distance, one or more angles such as azimuth or elevation, and other properties such as signal strength, radar cross section, velocity, etc.

An algorithm for acquiring the surroundings can be used to ascertain a position, a pose, a class and possibly other properties of relevant objects such as cars, trucks, pedestrians and/or other road users from a radar point cloud, for instance. With the development of deep learning technology, the conventional algorithms for acquiring the surroundings are increasingly being replaced by networks that use radar measurements, for example in the form of radar point clouds, to detect objects.

Current approaches for detecting objects project the radar point cloud into a Cartesian grid from a bird's eye view, which is then processed by a convolutional neural network (CNN).

In Niederlöhner, D., Ulrich, M., Braun, S., Köhler, D., Faion, F., Gläser, C., Treptow, A. and Blume, H., “Selfsupervised velocity estimation for automotive Radar object detection networks,” in 2022 IEEE Intelligent Vehicles Symposium (IV), pp. 352 bis 359, 2022, for example, Niederlöhner et al 2022 disclose a method for learning a Cartesian velocity of objects by means of a network for identifying objects using radar data from a vehicle.

In Ulrich, M., Braun, S., Köhler, D., Niederlöhner, D., Faion, F., Gläser, C. and Blume, H., “Improved orientation estimation and detection with hybrid object detection networks for automotive Radar,” in 2022 IEEE 25th International Conference on Intelligent Transportation Systems (ITSC), pp. 111-117, 2022, Ulrich et al. 2022 disclose use of relative positions of points to improve detection.

Different methods, for instance that have proven effective in the processing of LiDAR point clouds, can be used to project the radar point cloud into a grid.

In Yang, B., Luo, W. and Urtasun, R., “PIXOR: Realtime 3D Object Detection from Point Clouds”, arXiv:1902.06326, 2019, Yang et al. 2019 disclose the use of a depiction from a bird's eye view and the detection of objects with a CNN.

In Lang, A. H., Vora, S., Caesar, H., Zhou, L., Yang, J. and Beijbom, O., “PointPillars: Fast Encoders for Object Detection from Point Clouds,” arXiv:1812.05784, 2019, Lang et al. 2019 disclose a learned aggregation of radar points within a pillar.

The disclosed approaches can use proven network working architectures from the field of image processing. The use of a convolutional neural network with input data that represent radar measurements from a bird's eye view moreover makes it possible to utilize spatial context knowledge. It has thus been shown that grid-based methods are more likely to recognize a vehicle as such if there is also a road, for instance. Point-based methods represent an alternative to grid-based methods.

Svenningsson, P. Fioranelli, F. and Yarovoy, A., “Radar-PointGNN: Graph Based Object Recognition for Unstructured Radar Point-cloud Data,” in 2021 IEEE Radar Conference (RadarConf21), pp. 1 bis 6, 2021, Svenningsson et al. 2021 disclose the use of a graph-based neural network for processing a radar point cloud. Projection into a grid is therefore not necessary.

Information can be lost during processing; coarse rasterization, for example, can impair the accuracy of an estimate. A combination of grid-based methods and point-based methods is possible (see Ulrich et al. 2022) to compensate disadvantages and/or to combine the advantages of the different approaches.

The described methods typically use the entire radar point cloud consisting of data from static and dynamic objects. The data are fed into the network with a velocity measurement as a property of a radar point, such as a radar cross section.

In conventional systems, multiple measurement cycles are also aggregated over time to increase the radar point density. Niederlöhner et al. 2022, Ulrich et al. 2022 and Svenningsson et al. 2021 use radar measurements over a period of up to 0.5 seconds, for example, to increase detection performance. Aggregation over extended periods of time can lead to latency in detection, however, because networks prefer to detect an object based on data from multiple measurement cycles.

### SUMMARY

The present invention relates to a system, a device, and a method for detecting objects by separately processing data in multiple input paths of a network.

Preferred embodiments are disclosed herein.

Dynamic and static measurements are initially processed in separate network layers to enable the network to learn more meaningful features. Combining the two input paths in a deeper network level makes it possible to utilize the advantages of spatial context knowledge to increase detection performance while keeping the latency low. In other words, temporal aggregation is used without increasing the latency in the detection of dynamic objects.

According to a first aspect, the present invention relates to a method for detecting objects by separately processing point clouds comprising information about the surroundings of a system and/or a device. According to an example embodiment of the present invention, the method comprises: separating a point cloud into a plurality of point clouds according to one or more features of a plurality of features of each point of the point cloud; preprocessing the plurality of point clouds in a plurality of input paths of a network corresponding to the respective point cloud; fusing the output data of the plurality of input paths of the network; and further processing the fused output data in the network to detect the objects.

According to a further development of the present invention, the method further comprises acquiring information about the surroundings of the system and/or the device at one or more time points in order to generate a point cloud based on said acquired information.

According to a further development of the present invention, the separating further comprises filtering the point cloud according to a first time point of acquisition in order to preprocess the filtered point cloud in a first input path of the network.

According to a further development of the present invention, the separating further comprises aggregating the point cloud according to multiple time points of acquisition in order to preprocess the aggregated point cloud in a second input path of the network.

According to a further development of the present invention, a first input path of the plurality of input paths comprises preprocessing according to a first method and a second input path of the plurality of input paths comprises preprocessing according to a second method that is the same as or different from the first method.

According to a further development of the present invention, the separating is carried out for each point of the point cloud according to a threshold value for a radial velocity associated with the respective point.

According to a further development of the present invention, the preprocessing comprises projecting the point cloud into a grid and/or grouping the point cloud into pillars.

According to a further development of the present invention, the method further comprises outputting the detected objects.

According to a second aspect, the present invention relates to a non-volatile storage medium comprising instructions stored upon it that, when executed by a processor, cause said processor to carry out the above-described method of the present invention.

According to a third aspect, the present invention relates to a system and/or device, wherein the system and/or the device comprises: one or more sensors for acquiring information about the surroundings of the system and/or the device; a processor; and the above-described non-volatile storage medium.

### BRIEF DESCRIPTION OF THE DRAWINGS

FIG. 1 shows an illustration of a method for separately processing points by means of a network architecture comprising a plurality of input paths according to one example embodiment of the present invention.

FIG. 2 shows possible applications of the present invention in different embodiments of the present invention.

In all figures, identical or functionally identical elements and devices are provided with the same reference sign. The numbering of method steps is for the sake of clarity and is generally not intended to imply a specific chronological order. It is in particular also possible to carry out multiple method steps at the same time, e.g., in parallel.

### DETAILED DESCRIPTION OF EXAMPLE EMBODIMENTS

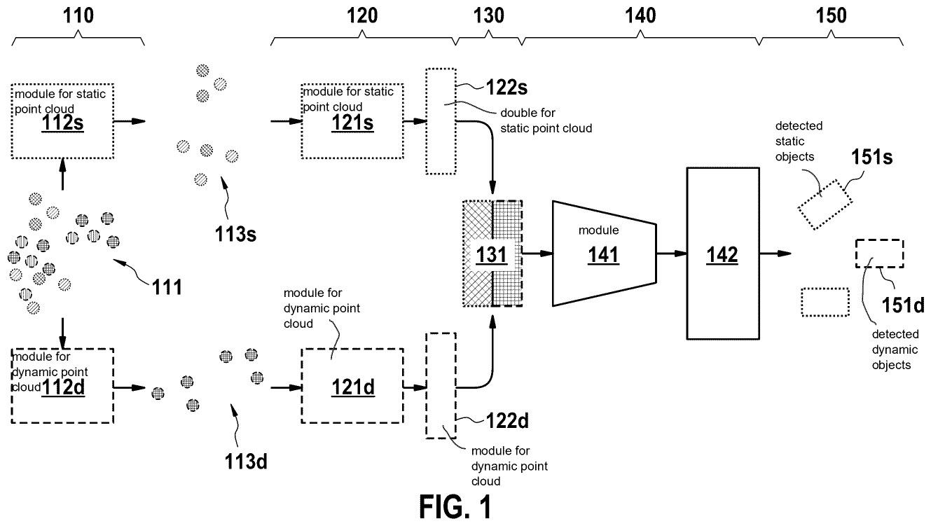

FIG. 1 illustrates a method for separately processing static and dynamic points of a point cloud 111 by means of a network architecture comprising two input paths according to one embodiment of the present invention. The method can be implemented in a module for processing the point cloud. The module can be compatible with a conventional method for processing a point cloud to acquire information about the surroundings of a system. The point cloud 111 is based on one or more measurements for acquiring information about the surroundings.

Electromagnetic radiation in different frequency ranges can be used to acquire information about the surroundings with different technologies, such as LiDAR (light detection and ranging, LiDAR) or radar (radio detection and ranging, radar). Acoustic waves can alternatively or additionally also be used to acquire information about the surroundings, for instance using ultrasound technology and/or sonar (sound detection and ranging, sonar) technology. Other technologies suitable for scanning the surroundings are possible as well.

A point of the point cloud 111 can be represented by a feature vector. The feature vector can have n dimensions, in which case n is a natural integer. The feature vector can, for example indicate features such as a position of a measurement (x-, y- and/or z-coordinate), a radar cross section, a radial velocity, a transverse velocity, a timestamp, for instance with a time of the measurement at which one or more features of the acquired feature vector were acquired, etc. The point cloud 111 can include points that correspond to information acquired at different times.

The method comprises separating 110 the points of the point cloud 111 based on one feature or based on multiple features of the points of the point cloud into two or more separate point clouds, for example a static point cloud 113s (dotted outlines) and a dynamic point cloud 113d (dashed outlines). The separating can be carried out by a module 112, which receives the points of the point cloud 111 as input and, for example, separates them into a static point cloud 113s and a dynamic point cloud 113d. The module 112 can be divided into separate modules, for example a module 112s for the static point cloud 113s and a module 112d for the dynamic point cloud 113d.

Based on one feature or based on multiple features of the feature vector, a point of the point cloud 111 can, for instance, be defined as either a static point or a dynamic point. A feature vector can be defined as static or dynamic based on a radial velocity and/or based on a transverse velocity, for example. If a radial and/or transverse velocity at a time of the measurement exceeds a threshold value, the point can be defined as a dynamic point. If a radial and/or transverse velocity at a time of the measurement falls below a threshold value, the point can be defined as a dynamic point.

The method further comprises preprocessing 120 the separate points of the point cloud based on the one feature or based on the multiple features of the points of the point cloud. Static points can be processed in a first path, for example, whereas dynamic points are preprocessed in a second path. Further paths are possible, too; for example, using multiple threshold values to distinguish velocity ranges for each point.

Separating 110 the points of the point cloud 111 can further comprise filtering based on a timestamp. Separating 110 the points of the point cloud can further comprise aggregating points over an aggregation period. The aggregation period can be different and/or adjustable, for example depending on one or more features of the points of the point cloud. An aggregation period for static points can be longer than an aggregation period for dynamic points, for instance, in order to reduce latency when detecting dynamic objects, for example in a velocity range above a threshold value or between threshold values that define the velocity range.

The separate, filtered and/or aggregated points can form a point cloud 113, in particular a plurality of point clouds, for example a static point cloud 113s and a dynamic point cloud 113d with points that have been aggregated over a respective different aggregation period. In FIG. 1, points having different timestamp are shown with different hatching patterns.

According to one example, the aggregation period for the static point cloud 113s in a first input path can be 0.5 seconds. The aggregation period for the dynamic point cloud 113d in a second input path can be less than 0.5 seconds, e.g. 0.1 seconds or less, e.g. 0.01 seconds, in order to keep the latency low.

Each of these point clouds can be preprocessed separately, for example projected into a separate two-dimensional grid and/or input into separate network layers of a conventional network for detecting objects, e.g. according to Niederlöhner et al. 2022, Ulrich et al. 2022, Yang et al. 2019 and/or Lang et al. 2019, in order to process the static and dynamic points separately in the separate network layers.

The projecting into a grid can be carried out, by a module 121, for instance, that receives the point cloud 113 as input. The module 121 can be divided into separate modules, for example a module 121s for the static point cloud 113s and a module 121d for the dynamic point cloud 113d.

The preprocessing in network layers of a conventional network can be carried out by a module 122, for example, that receives the point cloud 113, for instance, as input. The module 122 can be divided into separate modules, for example a module 122s for the static point cloud 113s and a module 122d for the dynamic point cloud 113d. The preprocessing 120 can be realized by two or more network working paths, for example, by implementing network working layers of the architecture being used twice or more.

According to one example, the preprocessing of the static or dynamic point cloud can be carried out according to Lang et al. 2019. A pillar module is used to project the points into a two-dimensional grid. Points located in a cell of the grid are grouped together in a pillar. The features of each point are individually embedded by a fully connected neural network. If multiple points fall into the same pillar, a max pooling (or some other pooling strategy) is applied across all points within the pillar to obtain a feature vector having a fixed length.

The method further comprises fusing 130 the outputs of the separate modules and/or network layers and further processing 140 the fused outputs. The fusing 130 can be carried out by concatenating the features from the network working layers of the plurality of network working paths and then entering them as input data into a remaining backbone for further processing, for instance into the module 141 of FIG. 1.

According to the example, the features extracted according to Lang et al. 2019, which are represented as a 3D tensor, can be further processed using a conventional 2D CNN that serves as a backbone. For the specific implementation, a backbone consisting of a residual network according to He, K., Zhang, X., Ren, S. and Sun, J., “Deep Residual Learning for Image Recognition,” in 2016 IEEE Conference on Computer Vision and Pattern Recognition (CVPR), pp. 770 to 778, He et al. 2016, and a feature pyramid network according to Lin, T.-Y., Dollár, P., Girshick, R., He, K., Hariharan, B. and Belongie, S., “Feature Pyramid Networks for Object Detection,” arXiv:1612.03144 2017, Lin et al. 2017, can be used, which is capable of extracting features for different resolutions of the two-dimensional grid.

The method also comprises further processing 140 the output data from the backbone by means of detection heads of the network to output 150 the detected static objects 151s and dynamic objects 151d.

According to the example, object probabilities for each grid cell, and also the regression parameters for an object box (position, length, width, height, orientation), can be estimated in the detection heads of the network.

In a generalized form, a method in the field of radar technology can be described as follows.

The input to the network is a list of points. The list of points can be unordered; their order can have no influence on the result of the method. Each point can be characterized by specific features as described above, in particular by its radar cross section and/or its radial velocity, which is compensated by the ego movement of the radar, for instance.

The output of the network can be a list of object hypotheses. For each object hypothesis, object properties such as an object type are predicted. A filter module makes it possible to separate radar point clouds into static and dynamic point clouds, for example based on the radial velocity compensated by the ego movement. Different temporal aggregation can be selected for static or dynamic points.

A module is then used for each input path to transform the radar points into a grid to subsequently process them in convolutional layers. Different network architectures can be used for this purpose. After the static or dynamic radar points have been processed separately in a plurality of network layers, the output data are fed into a common network architecture. A variety of conventional CNNs can be used for this purpose.

Various advantageous extensions or general changes to the described basic architecture are possible.

The two separate input paths are described as symmetrical, substantially identical input paths. The input paths can also be designed to be completely different, however. It is also possible that a change in resolution already takes place in this separate preprocessing to aggregate information from grid cells.

The network architecture can also be designed with more than two different input paths. For example, it is possible to have three input paths for static, slow-moving and fast-moving radar points using threshold values to define the different velocity ranges. The velocity ranges can align with local statutory legislation and/or be adjustable to correspond to the geographic position of a vehicle in which the vehicle is moving with the driver assistance system and/or autonomously.

The separate processing of static and dynamic radar points can be carried out using a grid-based and/or point-based method. For instance, it is also possible to process the dynamic radar points using a point-based method, while the static radar points are projected into a grid in order to utilize a CNN architecture. The output data of these different network approaches can then be fused into either a point-based representation or a grid-based representation, for example.

Point clouds and objects can be specified using any properties. Any backbones (CNN, point-processing network and/or others) and any detection heads can be used. Preprocessing of the point cloud by a further neural network is possible as well. In addition to object detection, the network can be used for any task in the automotive sector, e.g. semantic segmentation, tracking, etc.

Separate processing allows the separate network paths to be trained more specifically for the existing measurements. This enables the network to extract features even in measurements caused by static objects, for example, which are generally more difficult to detect with radar sensors.

Fusing the input paths in a later layer of the network architecture has the advantage that spatial context knowledge can be used to solve the detection task, despite the separation at the input.

Any input data can be used, e.g. radar spectra or point clouds from a LiDAR system or a time-of-flight camera. The filter module can also use any features or any combination of features, for example a velocity and elevation.

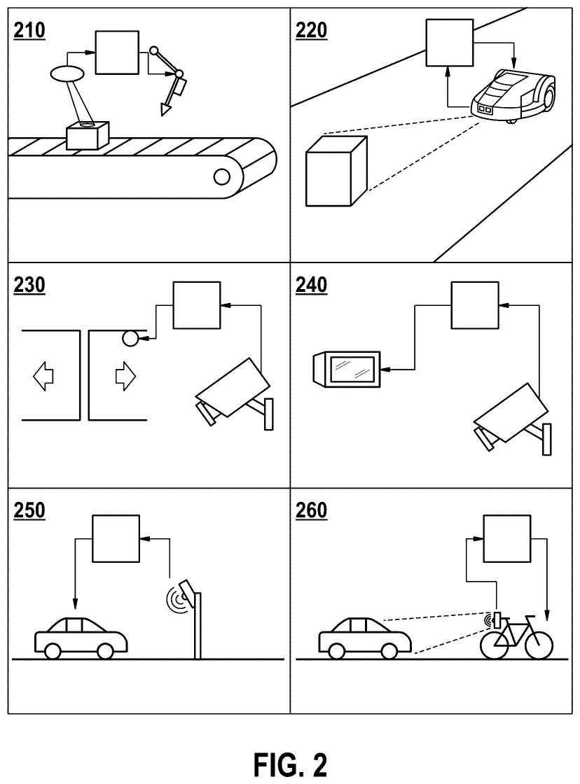

FIG. 2 shows possible applications of the present invention in different embodiments according to respective technical fields.

An automated assembly system 210 can include a device according to the present invention to detect components and/or their orientation in order to determine a gripping point.

Automated lawn mowers 220 or other robots, such as vacuum cleaners or logistics robots, can include a device according to the present invention for detecting obstacles.

Automatic access control systems 230 can include a device according to the present invention, for example to detect and/or identify persons for automatic door opening.

Automatic surveillance systems 240 for monitoring spaces or buildings can use a device according to the present invention to detect, check and classify goods, for example.

Automatic traffic monitoring systems 250 with stationary radar sensors can use a device according to the present invention to monitor traffic.

Assistance systems 260, for example for bicycles or other two-wheeled vehicles such as motorcycles or mopeds, can use a device according to the present invention to detect and classify road users.

What is claimed is:

1. A method for detecting objects by separately processing point clouds including information about surroundings of a system and/or a device, the method comprises the following steps:
separating a point cloud into a plurality of point clouds according to one or more features of a plurality of features of each point of the point cloud;
preprocessing the plurality of point clouds in a plurality of input paths of a network each corresponding to a respective point cloud;
fusing output data of the plurality of input paths of the network; and
further processing the fused output data in the network to detect the objects.

2. The method according to claim 1, further comprises acquiring information about the surroundings of the system and/or the device at one or more time points in order to generate the point cloud based on the acquired information.

3. The method according to claim 2, wherein the separating further includes filtering the point cloud according to a first time point of acquisition in order to preprocess the filtered point cloud in a first input path of the network.

4. The method according to claim 2, wherein the separating further includes aggregating the point cloud according to multiple time points of acquisition in order to preprocess the aggregated point cloud in a second input path of the network.

5. The method according to claim 1, wherein a first input path of the plurality of input paths includes preprocessing according to a first method and a second input path of the plurality of input paths includes preprocessing according to a second method that is the same as or different from the first method.

6. The method according to claim 1, wherein the separating is carried out for each point of the point cloud according to a threshold value for a radial velocity associated with the respective point.

7. The method according to claim 1, wherein the preprocessing includes projecting the point cloud into a grid and/or grouping the point cloud into pillars.

8. The method according to claim 1, wherein the method further comprises outputting the detected objects.

9. A non-volatile storage medium on which are stored instructions for detecting objects by separately processing point clouds including information about surroundings of a system and/or a device, the instructions, when executed by a processor, causing the processor to perform the following steps:
separating a point cloud into a plurality of point clouds according to one or more features of a plurality of features of each point of the point cloud;
preprocessing the plurality of point clouds in a plurality of input paths of a network corresponding to each respective point cloud;
fusing output data of the plurality of input paths of the network; and
further processing the fused output data in the network to detect the objects.

10. A system and/or device, comprising:
one or more sensors configured to acquire information about surroundings of the system and/or the device;
a processor; and
a non-volatile storage medium on which are stored instructions for detecting objects by separately processing point clouds including information about the surroundings of a system and/or a device, the instructions, when executed by a processor, causing the processor to perform the following steps:
separating a point cloud into a plurality of point clouds according to one or more features of a plurality of features of each point of the point cloud,
preprocessing the plurality of point clouds in a plurality of input paths of a network corresponding to each respective point cloud,
fusing output data of the plurality of input paths of the network, and
further processing the fused output data in the network to detect the objects.
